(19) United States
(12) Patent Application Publication
(10) Pub. No.: US 2014/0150591 A1
(43) Pub. Date: Jun. 5, 2014

(54) MULTI-PARALLEL MANIPULATOR SYSTEM

(71) Applicant: Guk Jin YANG, Yongin (KR)

(72) Inventor: Guk Jin YANG, Yongin (KR)

(21) Appl. No.: 14/088,395

(22) Filed: Nov. 23, 2013

(30) Foreign Application Priority Data
Dec. 5, 2012 (KR) 10-2012-0140026

(51) Int. Cl. B25J 18/00

(52) U.S. Cl. CPC B25J 18/00; Y10S 901/23
USPC 74/490.03; 74/490.05; 901/23

(57) ABSTRACT

A multi-parallel manipulator system is provided. The multi-parallel manipulator system includes a first parallel manipulator composed of two or more first drive modules and first movable members coupled to ends of the first drive modules, a second parallel manipulator composed of three or more second drive modules and second movable members coupled to ends of the second drive modules, and a fixture module serving as a fixture member configured to couple the first drive modules to the second drive modules. In this case, the first drive modules and the second drive modules may be alternately arranged with each other.

### CROSS-REFERENCE TO RELATED APPLICATION

This application claims priority to and the benefit of Korean Patent Application No. 10-2012-0140026, filed Dec. 5, 2012, the disclosure of which is incorporated herein by reference in its entirety.

### BACKGROUND

1. Field of the Invention

The present invention relates to a multi-parallel manipulator system, and, more particularly, to a multi-parallel manipulator system capable of controlling two or more movable members in a narrow space.

2. Discussion of Related Art

A parallel manipulator is an apparatus that is used in precision industry such as semiconductor industry, electronic parts, etc. In general, the parallel manipulator serves to move an object from space A to space B. As shown in FIG. 1, a conventional parallel manipulator 10 is configured to couple an object to a movable member 14 and move the object using a plurality of robot arms 13 and a movable member 14 attached to an end of one of the robot arms 13. A drive unit 12 is coupled respectively to the plurality of robot arms 13. The drive unit 12 includes motor devices to correspond to the robot arms 13, respectively. Each of the motor devices includes a motor and a gear module.

Because the parallel manipulator 10 includes the plurality of robot arms 13, when a worker want to work in a narrow space using two neighboring parallel manipulators, interference with the robot arms of the two parallel manipulators makes it difficult for the worker to work.

Although the parallel manipulator has an advantage in that it is stable in structure, it has a problem in that it is difficult to use several parallel manipulators together to work in a narrow space due to the problems as described above.

One example of technology associated with the present invention is Korean Patent Application No. 10-2011-0054463.

### SUMMARY OF THE INVENTION

The present invention is designed to solve the problems of the prior art, and therefore it is an object of the present invention to provide a multi-parallel manipulator system capable of independently applying two or more movable members so as to apply two or more parallel manipulators as if the parallel manipulators are present in the same space.

One aspect of the present invention provides a multi-parallel manipulator system including a first parallel manipulator composed of two or more first drive modules and first movable members coupled to ends of the first drive modules, a second parallel manipulator composed of three or more second drive modules and second movable members coupled to ends of the second drive modules, and a fixture module serving as a fixture member configured to couple the first drive modules to the second drive modules. Here, the first drive modules and the second drive modules are alternately arranged with each other

In this case, the numbers of the first drive modules and the second drive modules may be less than or equal to 16, each of the first drive modules may include a first motor device, and a first robot arm having a joint structure in which one end thereof is coupled to the first motor device and the other end thereof is coupled to the first movable member, and each of the second drive modules may include a second motor device, and a second robot arm having a joint structure in which one end thereof is coupled to the second motor device and the other end thereof is coupled to the second movable member.

Also, the multi-parallel manipulator system may further include a connection member bound between the first movable member and the second movable member.

### BRIEF DESCRIPTION OF THE DRAWINGS

The above and other objects, features and advantages of the present invention will become more apparent to those of ordinary skill in the art by describing in detail exemplary embodiments thereof with reference to the attached drawing, in which:

FIG. 1 is a perspective view showing a conventional parallel manipulator in the present invention;

FIG. 2 is a perspective view showing a multi-parallel manipulator according to one exemplary embodiment of the present invention; and

FIG. 3 is a perspective view showing the multi-parallel manipulator according to one exemplary embodiment of the present invention (with a connection member being coupled thereto).

### DETAILED DESCRIPTION OF EXEMPLARY EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

With reference to the appended drawings, exemplary embodiments of the present invention will be described in detail below. To aid in understanding the present invention, like numbers refer to like elements throughout the description of the figures, and the description of the same elements will be not reiterated.

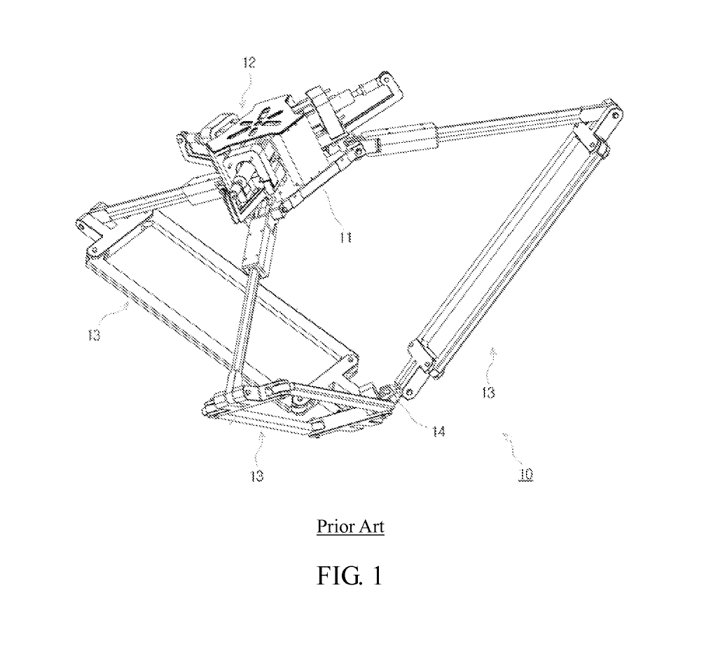

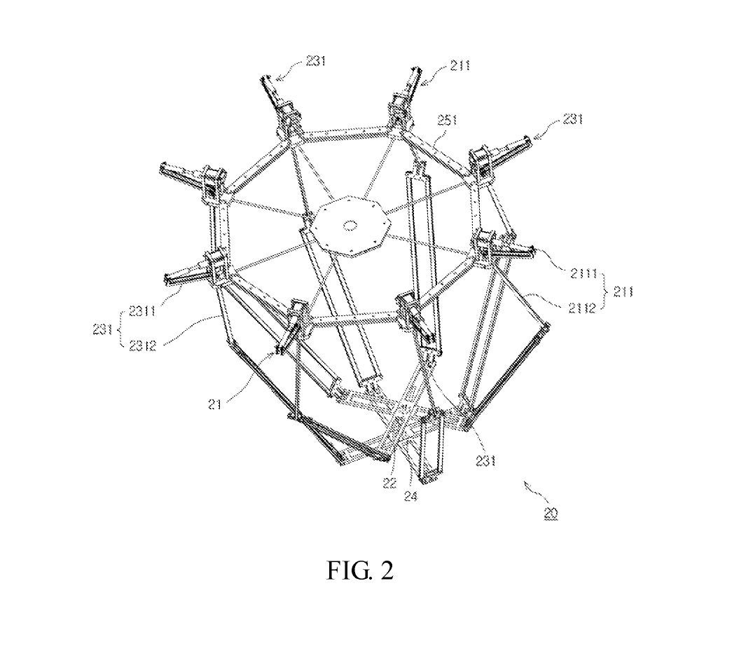

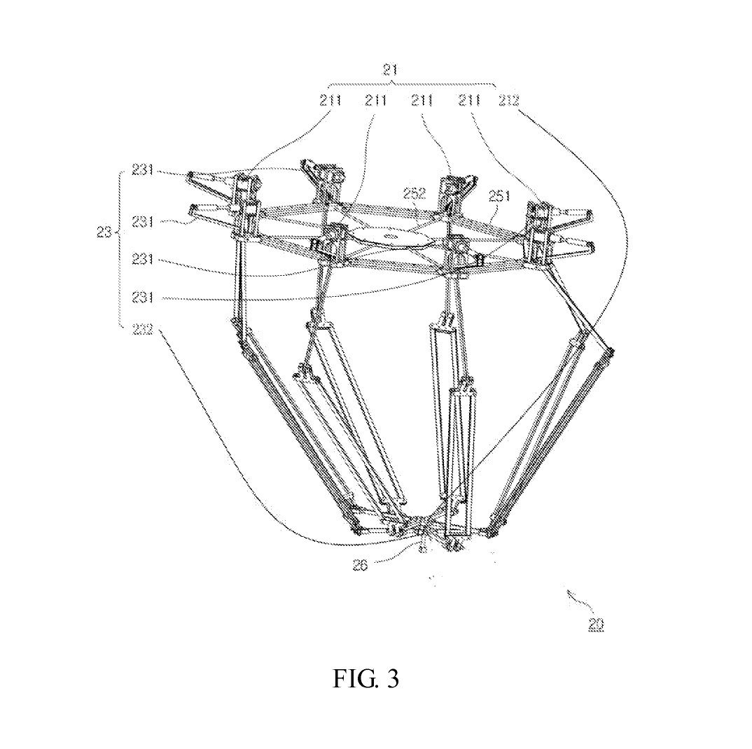

FIG. 1 is a perspective view showing a conventional parallel manipulator in the present invention, FIG. 2 is a perspective view showing a multi-parallel manipulator according to one exemplary embodiment of the present invention, and FIG. 3 is a perspective view showing the multi-parallel manipulator according to one exemplary embodiment of the present invention (with a connection member being coupled thereto).

A multi-parallel manipulator system 20 according to this exemplary embodiment is characterized in that it includes a first parallel manipulator 21 composed of two or more first drive modules 211 and first movable members 212 coupled to ends of the first drive modules 211, a second parallel manipulator 23 composed of three or more second drive modules 231 and second movable members 232 coupled to ends of the second drive modules 231, and a fixture module 251 configured to couple the first drive modules 211 to the second drive modules 231. In this case, the first drive modules 211 and the second drive modules 231 may be alternately arranged with each other.

The multi-parallel manipulator system 20 according to this exemplary embodiment is driven as if the two parallel manipulators are operated in the same space. The first parallel manipulator 21 and the second parallel manipulator 23 are independently driven to control the first movable member 212 and the second movable member 232, respectively. The first movable member 212 may be arranged on the second movable member 232, and allowed to move the second movable member 232 in a state in which the first movable member 212 is horizontally crossed with the second movable member 232.

The first parallel manipulator 21 is composed of two or more first drive modules 211. Each of the first drive modules 211 is configured to include a first motor device 2111 and a first robot arm 2112 having a joint structure in which one end thereof is coupled to the first motor device 2111 and the other end thereof is coupled to the first movable member 212.

Each of the first motor devices 2111 may be composed of a motor and a gear module. Each of the first motor devices 2111 serves to control the first robot arm 2112 so as to move the first movable member 212 to a desired position. The first parallel manipulator 21 is composed of at least two first drive modules 211. In this case, the three first parallel manipulators 21 are required to move the first movable member 212 in a three-dimensional manner. In this exemplary embodiment, the four first drive modules 211 may be used to move the first movable member 212.

The first movable member 212 is coupled to one end of each of the first drive modules 211. A workpiece is coupled to the first movable member 212 and allowed to move, or a tool is coupled to make a working operation.

The second parallel manipulator 23 is composed of three or more second drive modules 231. Each of the second drive modules 231 is configured to include a second motor device 2311, and a second robot arm 2112 having a joint structure in which one end thereof is coupled to the second motor device 2311 and the other end thereof is coupled to the second movable member 232.

Each of the second motor devices 2311 may be composed of a motor and a gear module. Each of the second motor devices 2311 serves to control a second robot arm 2312 so as to move the second movable member 232 to a desired position. The second parallel manipulator 23 is composed of three or more second drive modules 231. In this exemplary embodiment, the four second drive modules 231 may be used to move the second movable member 232.

The second movable member 232 is coupled to one end of each of the second drive modules 231. A workpiece is coupled to the second movable member 232 and allowed to move, or a tool is coupled to make a working operation.

The fixture module 251 serves to couple the first drive modules 211 to the second drive modules 231. More particularly, the fixture module 251 may also couple the first drive modules 211 to the motor devices 2111 and 2311 of the second drive modules 231.

Meanwhile, the first drive modules 211 and the second drive modules 231 may be mixed in an alternating manner. As described in this exemplary embodiment, the four first drive modules 211 and the four second drive module 231 may be alternately arranged with each other, or some of the four first drive modules 211 and the four second drive module 231 may be arranged in an alternating manner. As such, the first drive modules 211 and the second drive modules 231 may be arranged in an alternating manner to alternate the first robot arms 2112 and the second robot arms 2312. As a result, the first movable members 212 coupled to the first robot arms 2112 and the second movable members 232 coupled to the second robot arms 2312 may be allowed to move in a state in which the first movable members 212 are horizontally crossed with the second movable members 232 in a vertical direction.

The number of the first drive modules 211 may be greater than or equal to 2. Preferably, the number of the first drive modules 211 may be less than or equal to 16. In addition, the number of the second drive modules 231 may be greater than or equal to 3. Preferably, the number of the second drive modules 231 may be less than or equal to 16.

Meanwhile, the multi-parallel manipulator system according to this exemplary embodiment may further include a connection member 26 bound between the first movable member 212 and the second movable member 232. As the connection member 26 is bound between the first movable member 212 and the second movable member 232, the first movable member 212 and the second movable member 232 may move within an extension limit of the connection member 26. That is, the first parallel manipulator 21 and the second parallel manipulator 23, which have been controlled in a separate manner, may also be controlled like one parallel manipulator.

For the multi-parallel manipulator system 20 configured thus, the first parallel manipulator 21 and the second parallel manipulator 23 have been exemplified, and the configurations of the two parallel manipulators have been described herein. However, a third parallel manipulator may also be further bound therebetween. Accordingly, it should be understood that a combination of the three or more parallel manipulators falls within the scope of the present invention.

The present invention provides a multi-parallel manipulator system capable of independently applying two or more movable members so as to apply two or more parallel manipulators as if the parallel manipulators are present in the same space.

While the invention has been shown and described with reference to certain exemplary embodiments thereof, it will be understood by those skilled in the art that various changes in form and details may be made therein without departing from the scope of the invention as defined by the appended claims.

What is claimed is:

1. A multi-parallel manipulator system comprising:
a first parallel manipulator composed of two or more first drive modules and first movable members coupled to ends of the first drive modules;
a second parallel manipulator composed of three or more second drive modules and second movable members coupled to ends of the second drive modules; and
a fixture module serving as a fixture member configured to couple the first drive modules to the second drive modules,
wherein the first drive modules and the second drive modules are alternately arranged with each other.

2. The multi-parallel manipulator system according to claim 1, wherein the numbers of the first drive modules and the second drive modules are less than or equal to 16,
each of the first drive modules comprises:
a first motor device; and
a first robot arm having a joint structure in which one end thereof is coupled to the first motor device and the other end thereof is coupled to the first movable member, and
each of the second drive modules comprises:
a second motor device; and
a second robot arm having a joint structure in which one end thereof is coupled to the second motor device and the other end thereof is coupled to the second movable member.

3. The multi-parallel manipulator system according to claim 2, further comprising a connection member bound between the first movable member and the second movable member.
